(19) United States
(12) Patent Application Publication
(10) Pub. No.: US 2006/0128932 A1
(43) Pub. Date: Jun. 15, 2006

(54) Photo-crosslinkable composition for step-index plastics optical fiber material

(76) Inventors: Jerome Fournier, Lyon (FR); Jerome Alric, L'isle D'abeau (FR); Elisabeth Tavard, Lyon (FR)

Correspondence Address: SOFER & HAROUN, L.L.P., Suite 910, 317 Madison Avenue, New York, NY, 10017, US

(21) Appl. No.: 11/280,936

(22) Filed: Nov. 15, 2005

(30) Foreign Application Priority Data
Nov. 15, 2004 (FR) 04 52627

(51) Int. Cl. C08G 63/00

(52) U.S. Cl. 528/191

(57) ABSTRACT

The present invention provides a photo-crosslinkable composition for fabricating a material for a step-index plastics optical fiber. The invention is remarkable in that the photo-crosslinkable composition comprises an acrylate derivative of a compound based on bisphenol, and a photoinitiator.

### RELATED APPLICATION

This application is related to and claims the benefit of priority from French Patent Application No. 04 52627, filed on Nov. 15, 2004, the entirety of which is incorporated herein by reference.

### FIELD OF THE INVENTION

The present invention relates to a photo-cross-linkable composition for use in fabricating a material that is usable in a step-index plastics optical fiber, as core material and/or as cladding material.

The invention also relates to a method of fabricating such a material, and more widely a step-index plastics optical fiber made from at least one material derived from such a photo-crosslinkable composition.

A particularly advantageous, but non-exclusive application of the invention lies in the field of optical telecommunications.

### BACKGROUND OF THE INVENTION

Nowadays, thermoplastic fibers based on polymethylmethacrylate (PMMA) constitute the step-index plastics optical fibers that are in the most widespread use. This is explained essentially by the fact that although the method of fabrication is complex, it is at present the only method to be fully mastered from an industrial point of view.

Although thermoplastic fibers based on PMMA provide optical properties that are entirely satisfactory, and in particular a level of light attenuation that is less than 1000 decibels per kilometer (dB/km), they nevertheless present the drawback of having a relatively low high temperature limit, in any event low enough to make them practically unusable if ever the utilization temperature exceeds 100° C. As a result, in practice, the use of this type of plastics optical fiber is restricted to thermal environments that are not difficult, i.e. in which the utilization temperature is generally less than 80° C.

Naturally, this limitation considerably restricts the fields in which PMMA-based thermoplastic fibers can be applied, and thus more generally restricts their advantages. Fields in which fast communication means are in demand, such as automobiles and airplanes, have difficulty in accommodating such fibers, given that locations such as engine compartments are unsuitable for receiving them.

### OBJECTS AND SUMMARY OF THE INVENTION

Thus, the technical problem to be solved by the subject matter of the present invention is to propose a photo-crosslinkable composition for use in fabricating material for a step-index plastics optical fiber, which composition makes it possible to avoid the problems of the prior art by presenting, once crosslinked, significantly improved ability to withstand high temperatures, while nevertheless offering optical performance compatible with transmitting light signals over short distances, typically over about 10 meters.

According to the present invention, the solution to the technical problem posed consists in that the photo-crosslinkable composition comprises an acrylate derivative of a compound based on bisphenol, together with a photoinitiator.

It should be observed that the fact that the photo-crosslinkable composition is for fabricating material for a step-index plastics optical fiber means that it can be used equally well for making a core material or a cladding material. Consequently, this implies that a plastics optical fiber in accordance with the invention could equally well have either only its core fabricated using a photo-crosslinkable composition as described above, or only its cladding coming from such a composition, or both its core and its cladding being made using said composition.

The invention as defined presents the advantage of enabling a crosslinked material to be obtained that presents firstly good mechanical properties at high temperature, up to temperatures close to 120° C., and secondly a level of light attenuation that is less than 1000 dB/km, with a lower limit that may be as little as 500 dB/km.

Another advantage of a photo-crosslinkable composition in accordance with the invention lies in its extremely low cost price, which has a favorable and direct influence on the cost of the step-index plastics optical fiber. At present, it appears to be entirely possible to envisage reducing the price per kilometer by a factor of 8.

According to a feature of the invention, the acrylate derivative is selected from an acrylate, a methacrylate, and an α-fluoroacrylate. In this respect, it is known that acrylate functional groups in radical polymerization present reactivity greater than that of methacrylate groups. Thus, the acrylate derivative is preferably of the acrylate type, with this naturally being independent of the exact nature of the bisphenol-based compound under consideration.

According to another feature of the invention, the compound from which the acrylate derivative stems is an alkoxy derivative of a bisphenol.

In particularly advantageous manner, the alkoxy derivative is selected from an ethoxy derivative of a bisphenol and a propoxy derivative of a bisphenol.

Preferably, the bisphenol based on the acrylate compound is selected from bisphenol A, bisphenol AF, bisphenol M, bisphenol P, bisphenol AP, and bisphenol S.

According to another feature of the invention, the photo-crosslinkable composition may further comprise a crosslinking agent suitable for optimizing the polymerization reaction. The crosslinking agent may, a priori, be of any known kind.

In particularly advantageous manner, the concentration of the crosslinking agent within the photo-crosslinkable composition lies in the range 0.5% to 5% by weight.

According to another feature of the invention, the viscosity of the acrylate derivative lies in the range 0.5 pascal seconds (Pa.s) to 20 Pa.s, and preferably in the range 1 Pa.s to 5 Pa.s.

The invention also provides a method of fabricating a material for use in the fabrication of a step-index plastics optical fiber. It should be understood that the material may equally well be a core material or a cladding material. In any event, such a method is remarkable in that it comprises the steps consisting in:

mixing an acrylate derivative of a compound based on a bisphenol and a photoinitiator in order to obtain a photo-crosslinkable composition;

shaping the composition that results from the mixing; and

crosslinking the previously-shaped composition by ultraviolet radiation.

It should be observed that the acrylate derivative of a bisphenol-based compound should be considered as being an oligomer. Once the oligomer has been mixed with its photoinitiator, a polymerization reaction begins such that the composition takes on more or less quickly a consistency that is sufficient to enable it to be shaped in the second step of the method. The crosslinking that is performed subsequently enables the material to be frozen in its final utilization shape.

According to a feature of the method, a step of filtering the acrylate derivative may be implemented prior to the mixing step.

According to another feature of the method, a cross-linking agent may be added to the composition during the mixing step.

According to another feature of the invention, the ultraviolet radiation crosslinking step is implemented continuously.

According to another feature of the invention, the method may also include an annealing step which is implemented after the crosslinking step.

Naturally, the invention also provides any step-index plastics optical fiber including a core constituted by a core material and cladding constituted by a cladding material in which at least one of the core and cladding materials is made using a photo-crosslinkable composition as defined above.

### BRIEF DESCRIPTION OF THE DRAWINGS

Other characteristics and advantages of the present invention appear from the following description. The description is given by way of non-limiting example and seeks to provide a better understanding as to what the invention consists in and how it can be implemented. The description is given with reference to the accompanying drawings, in which:

FIG. 1 is a diagram of apparatus for fabricating step-index plastics optical fibers in accordance with the invention;

FIG. 2 is a diagram showing the influence of increasing quantities of crosslinking agent on the mechanical properties at high temperatures of materials in accordance with the invention;

FIG. 3 shows spectra of light losses revealing the effect of filtering compositions in accordance with the invention on the optical performance of fibers made therefrom;

FIG. 4 shows attenuation spectra illustrating the optical performance of fibers provided with core materials of different compositions;

FIG. 5 shows attenuation spectra revealing the optical performance of a fiber that has been subjected to high temperature external aging at 100° C. for different lengths of time; and

FIG. 6 is a diagram similar to that of FIG. 5, but for thermal aging performed at 120° C.

### MORE DETAILED DESCRIPTION

Seven step-index plastics optical fibers were prepared in order to determine the mechanical properties at high temperatures and the optical performance of core materials made using compositions in accordance with the invention. Another objective was to make comparisons with the mechanical properties of a commercially-available conventional plastics optical fiber, in particular a PMMA-based fiber.

It should be observed that the seven plastics optical fibers of the invention differed from one another solely in the compositions of their respective core materials. Consequently, this implies that the cladding material was the same for all of the fibers, as was the fabrication method used.

In this respect, it should be observed that the fabrication of the plastics optical fibers in question consisted essentially in preparing separately the different compositions for the core material and for the cladding material, and then combining them by implementing a continuous fabrication process involving crosslinking by exposure to ultraviolet radiation.

Preparation of Core Materials

Seven compositions for core materials were thus prepared from three distinct ingredients suitable for use in varying proportions, i.e. an oligomer, a photoinitiator, and where appropriate a crosslinking agent. It should be understood that the simultaneous presence of the oligomer and of the photoinitiator is essential in accordance with the present invention.

Table 1 gives the respective compositions of the various core materials used for fabricating the seven plastics optical fibers.

TABLE 1

| | | | | Filter |
|---|---|---|---|---|
| | Oligomer | Crosslinking agent | Photoinitiator | threshold |
| Fiber | (% by weight) | (% by weight) | (% by weight) | (μm) |
| 1 | 100 | 0 | 1 | 0.2 |
| 2 | 100 | 0 | 0.2 | 10 |
| 3 | 100 | 0 | 0.2 | 0.2 |
| 4 | 97.5 | 2.5 | 0.2 | 0.2 |
| 5 | 95 | 5 | 0.2 | 0.2 |
| 6 | 92.5 | 7.5 | 0.2 | 0.2 |
| 7 | 90 | 10 | 0.2 | 0.2 |

The core oligomer was naturally in accordance with present invention. In this example, it was ethoxylated bisphenol A (3) diacrylate sold under the trademark SR349 by the supplier Cray Valley. Its developed chemical formula is as follows:

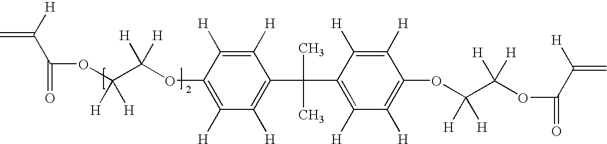

The crosslinking agent was tris(2-hydroxyethyl)isocyanurate triacrylate, sold under the name SR368 by the supplier Cray Valley.

The photoinitiator was bisphenyl(2,4,6-trimethyl benzoyl) phosphine oxide, sold under the trademark IRGACURE 819 by the supplier CIBA.

Preparing the Cladding Materials

As stated above, the cladding material was common to the seven plastics optical fibers in accordance with the invention, both in terms of composition and in terms of the proportions of the various ingredients. It comprised a mixture of 80% by weight of an oligomer, 10% by weight of a reactive diluent for lowering viscosity and for adjusting the refractive index of the cladding material, and 10% by weight of a hardening agent which, as its name indicates, was for hardening said cladding material.

In this example, the cladding oligomer was a trifunctional aliphatic epoxy acrylate oligomer sold under the name CN133 by the supplier Cray Valley.

The reactive diluent was trifluoroethyl acrylate sold under the trademark VISCOAT 3F™ by the supplier KOWA.

The hardening agent was hexafluoroisopropyl α-fluoroacrylate sold under the trademark FAHFIP by the supplier P&M.

Fabricating Step-Index Plastics Optical Fibers

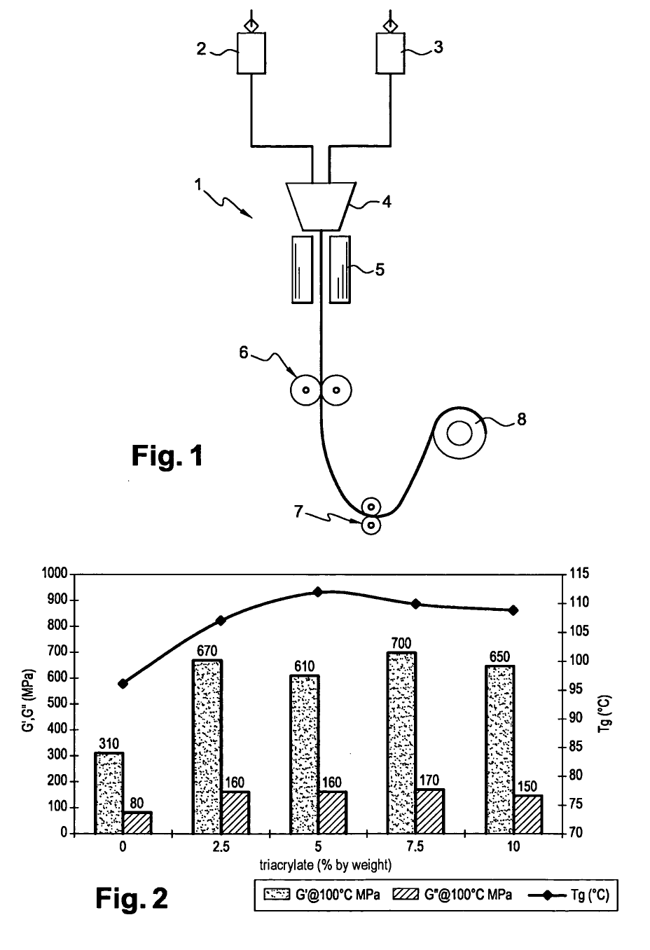

FIG. 1 is a diagram of the apparatus 1 that was used for making each of the plastics optical fibers. Thus, the previously prepared core and cladding compositions were filtered and then placed respectively in two feeder tanks 2 and 3 which were temperature-regulated. Using nitrogen under pressure, the resins were subsequently sent individually into a mixer 4 suitable for organizing them to comply with a step-index type profile. The flow generated in that way then passed through a die (not shown for reasons of clarity) serving to reduce the diameter to a predetermined value, prior to beginning to apply the ultraviolet radiation treatment. The crosslinking operation was thus performed directly at the outlet from the die. Specifically, the flow was directed through a chest 5 containing a mercury lamp suitable for irradiating the flow continuously as it passed through the chest. Once the core and cladding materials have crosslinked, the plastics optical fiber as such has been made. It can then be collected by means of a system of moving wheels 6, 7 so as to be wound onto a spool 8.

The advantage of the above-described fabrication apparatus 1 is that it enables the process to be performed entirely continuously, including the cross-linking step. It is thus possible to achieve fabrication speeds exceeding 100 meters per minute (m/min) which is much greater than can usually be obtained with a conventional extrusion method of the kind usually implemented for fabricating plastics optical fibers based on drawing-down preforms based on PMMA.

Another advantage lies in the ability to adjust the ratio between the volume of core material and the volume of cladding material merely by varying the diameter of the die and/or the pressure of the nitrogen and/or the temperatures of the feeder tanks 2, 3.

In any event, the step-index plastics optical fiber obtained thereby advantageously presents a very fine interface between the core and the cladding, accompanied by good concentricity between those two component elements.

To return more specifically to the example selected for determining and comparing the high temperature mechanical properties and the optical performance of the materials in accordance with the invention, it should be observed that the plastics optical fibers that were fabricated all presented outside diameters lying in the range 600 micrometers (μm) to 950 μm, with the diameters of the various cores lying in the range 500 μm to 750 μm.

High Temperature Mechanical Properties of the Core Materials

The various core materials were prepared by varying the contents of the crosslinking agent and of the photoinitiator, while also modifying the filter thresholds of the corresponding compositions. It is then appropriate to examine the influence of each of those variables on the high temperature mechanical properties of the core materials.

That is why the investigation began by studying the relationship between the quantity of crosslinking agent present in each composition and the storage modulus G′, the loss modulus G″, and the glass transition temperature Tg of the corresponding crosslinked material. The core materials concerned are those of fibers 3 to 7 (Table 1). The results are summarized diagrammatically in the graph of FIG. 2. Since the glass transition temperature of tris(2-hydroxyethyl)isocyanurate triacrylate is 272° C., a small quantity of crosslinking agent in a composition leads to an increase in the Tg of the corresponding crosslinked material, because of an increase in the density of crosslinking.

As can be seen in FIG. 2, whereas the glass transition temperature of the material based on pure oligomer was measured as being 96° C., the crosslinked material containing 5% by weight of the crosslinking agent saw its Tg raised to 112° C. In parallel, it xas observed that the storage modulus and the loss modulus were preserved to some extent from ambient temperature to 100° C., which appears logical given that the glass transition temperature was not exceeded.

It should also be observed that the glass transition temperature does not increase with increasing quantities of crosslinking agent. On the contrary, it begins to decrease once the content exceeds 5% by weight. This can be explained by the fact that the acrylate groups of the crosslinking agent are difficult to access because of the very dense chemical structure of said agents, such that they cannot all react simultaneously when said cross-linking agent is at a high concentration in the photo-crosslinkable composition. The crosslinking agent then performs an opposite function, that of a plasticizing agent.

The mechanical properties of the plastics optical fibers 1, 3, and 5 are summarized in Table 2, and compared with those of a conventional plastics optical fiber based on PMMA. Specifically, that fiber was a fiber sold under the name ESKA10 by the supplier MITSUBISHI RAYON Co. That fiber is characterized in particular by an outside diameter of 250 μm.

TABLE 2

| | Stress at | | | |
|---|---|---|---|---|
| | plastic | | | |
| | deformation | Young's | Breaking | Breaking |
| Fiber | threshold (%) | modulus (MPa) | elongation (%) | stress (MPa) |
| 1 | 5.5 ± 0.1 | 1600 ± 100 | 11 ± 2 | 54 ± 4 |
| 3 | 5.5 ± 0.1 | 1450 ± 90 | 10 ± 2 | 45 ± 3 |
| 5 | 5.5 ± 0.1 | 1680 ± 50 | 10 ± 2 | 49 ± 2 |
| PMMA | 5.7 ± 0.2 | 3410 ± 60 | 167 ± 7 | 193 ± 9 |

Because of their crosslinked structures, the plastics optical fibers in accordance with the invention present breaking stresses that are lower than those of the PMMA plastics optical fiber, i.e. of the fiber based on a thermoplastic material.

Nevertheless, the stresses at the plastic deformation threshold are comparable, which means that the plastics optical fibers based on crosslinked materials are as easy to handle as the PMMA plastics optical fiber. Furthermore, in spite of having lower values for Young's modulus, the plastics optical fibers based on crosslinked materials are strong enough mechanically speaking to withstand a rewinding step without breaking.

It should also be observed that the content of photoinitiator or the presence of the crosslinking agent does not fundamentally modify the mechanical properties, even though Young's modulus is slightly greater when said crosslinking agent is used in the core material composition (fiber 5).

The mechanical properties of fiber 1 compared with those of fiber 3 are of substantially the same order, which means that photo-crosslinking has the same effectiveness on the conversion rate of the material, and thus on the crosslinking density of the material, even when the content of photoinitiator differs by a factor of 5.

At this stage of the analysis, it can be seen that the combined use of a pure oligomer and a small quantity of photoinitiator is capable of producing a plastics optical fiber having mechanical properties of satisfactory level, in particular for applications in the automotive field.

The Influence of the Key Parameters of the Fabrication Process on the Optical Properties of Step-Index Plastics Optical Fibers

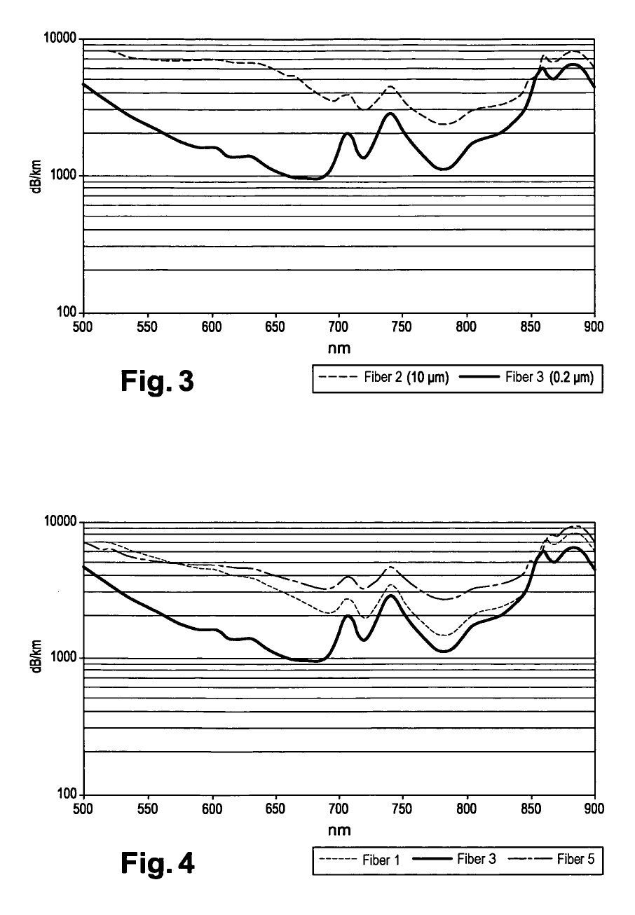

The impact of the filter threshold on the overall attenuation level of the plastics optical fibers was investigated initially. In this respect, FIG. 3 enables the light loss spectra of fibers 2 and 3 to be compared.

It can be seen that fiber 2, having core material made using a composition previously filtered with a 10 μm filter, presents a level of attenuation that is higher than that of fiber 3 for which the core material was derived from a composition previously filtered with a 0.2 μm filter. The higher diffusion losses in the 500 nanometer (nm) to 700 nm range reveal the presence of dust particles that were effectively removed from the core composition once the filtering was performed more finely.

Thus, it can clearly be seen that pollution by dust particles of a size greater than λ/10, where λ is the wavelength of the light signal, has an entirely harmful effect on the overall attenuation level; this effect is revealed by an increase in diffusion losses.

The effect of the uniformity of the core materials on the optical properties of step-index fibers was then examined. For this purpose, FIG. 4 shows the light loss spectra of three plastics fibers prepared using different core material compositions.

The core materials of fiber 1 and fiber 3 were both made using a pure oligomer, in the sense that they did not contain any crosslinking agent. Nevertheless, they differed from each other in that the photoinitiator content was only 0.2% by weight for the core material of fiber 3, whereas it was 1% by weight for that of fiber 1. The core materials of fibers 3 and 5 differed solely by the presence of the crosslinking agent in the core material of fiber 5, the photoinitiator content being the same in both cases.

Comparing the spectra of FIG. 4 shows clearly that the photoinitiator acts as contamination that degrades optical performance. The overall level of attenuation of fiber 1 is considerably greater than that of fiber 3. This means that by reducing the photoinitiator content by a factor of 5, the minimum attenuation value in the 650 nm to 700 nm region is lowered by more than 1000 dB/km.

Given that the mechanical properties of a plastics optical fiber are not greatly affected by a low photoinitiator content (see Table 2), it can be concluded that the use of a minimum quantity of photoinitiator makes it possible, advantageously, to obtain a core material having improved optical properties.

Comparing the spectra of FIG. 4 also shows that the presence of crosslinking agent in the core material composition (fiber 5) leads to a significant decrease in the optical performance of the corresponding plastics optical fiber.

This result can be explained by the material presenting greater structural non-uniformity that results from the fact that crosslinking in fiber 5 took place on a genuine mixture made up of non-negligible quantities of oligomer and of crosslinking agent. Consequently, it is not illogical for the number of imperfections within the core material to be increased, leading to greater levels of light losses by diffusion.

Thus, in spite of raising the glass transition temperature of the material by about 20%, the use of the crosslinking agent is of no use in improving the high temperature properties of a step-index plastics optical fiber.

Investigating High Temperature Behavior

The behavior of fiber 3 at high temperature was investigated by comparing its optical performance and its mechanical properties before and after heating to distinct temperatures of 100° C. and 120° C., in each case for determined durations of 100 hours (h) and 300 h.

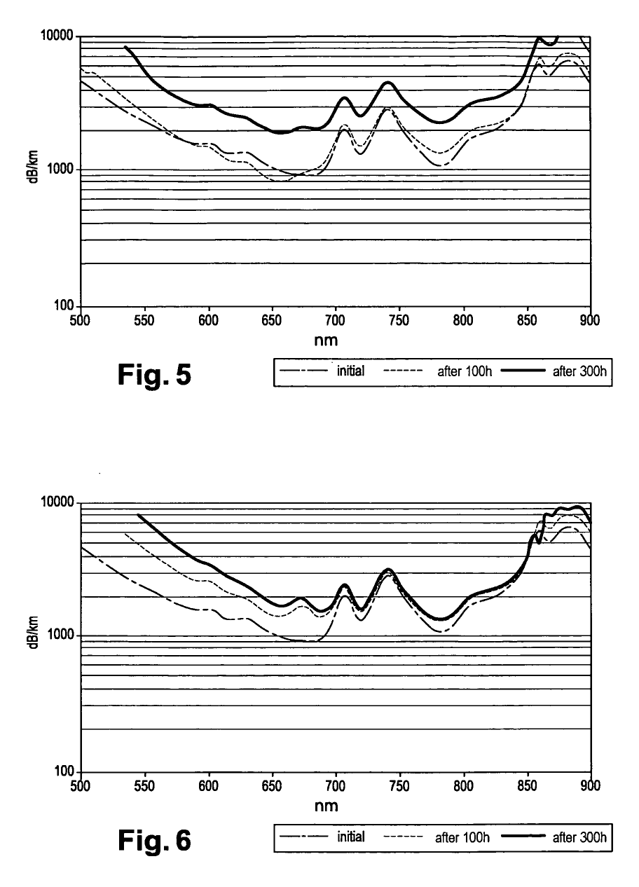

More particularly, FIG. 5 superposes the light loss spectra of fiber 3 respectively before being heated, after being heated to 100° C. for 100 h, and after being heated to 100° C. for 300 h.

The main point to observe is that thermal aging for a duration of 100 h has little effect on the overall optical performance of the fiber. Indeed losses in the 600 nm to 700 nm region even turn out to be slightly smaller after heating. This could be explained equally well by the effect of the resulting subsequent heat treatment that might have acted on the residual acrylic groups, and by the material relaxing that might have taken place because the heat treatment in question was carried out below the glass transition temperature.

Whatever the explanation, this observation confirms the benefit that subsequent heat treatment can provide in addition to the initial photo-crosslinking, in particular for eliminating the internal structural stresses of the materials and for improving the optical performance of the corresponding plastics optical fiber.

The mechanical properties of fiber 3, before and after thermal aging are presented in Table 3.

TABLE 3

| | Stress at | | | |
|---|---|---|---|---|
| Temperature | plastic | Young's | Breaking | Breaking |
| (° C.)/ | deformation | modulus | elongation | stress |
| time (h) | threshold (%) | (MPa) | (%) | (MPa) |
| Ambient/t₀ | 5.5 ± 0.1 | 1540 ± 90 | 10 ± 2 | 45 ± 3 |
| 100° C./100 h | 4.9 ± 0.1 | 2040 ± 200 | 7 ± 1 | 57 ± 3 |
| 100° C./300 h | 5.0 ± 0.1 | 2110 ± 120 | 5.8 ± 0.6 | 62 ± 2 |
| 120° C./100 h | 5.3 ± 0.1 | 1800 ± 70 | 8 ± 2 | 52 ± 1 |
| 120° C./300 h | 4.9 ± 0.2 | 2350 ± 100 | 6.4 ± 0.7 | 65 ± 3 |

The higher values for Young's modulus and breaking stresses confirm the effect of the subsequent heat treatment on the residual acrylic groups.

It can also be seen that the mechanical properties of fiber 3 were not affected by the thermal aging, even when the plastics optical fiber was treated at 120° C., i.e. about 30° C. above the glass transition temperature of the core material.

However, once thermal aging at 100° C. is carried out for 300 h, the results are quite different in terms of optical performance. A very significant increase in the light losses of the fiber can be observed, an increase of the order of 1000 dB/km.

The explanation stems a priori from the fact that losses by dispersion, due to structural imperfections in the material are probably increased after heating. Since the material was treated above its glass transition temperature for a long time, it is not illogical to assume that its structure might have been damaged locally thereby.

Similar observations were made when fiber 3 was treated at a temperature of 120° C. The thermal aging likewise led to an increase in light losses, but without that affecting the mechanical properties of the fiber. The increase in the overall optical attenuation, which does not depend on wavelength, shows that thermal aging affects optical signal transmission properties.

FIG. 6 superposes the spectra of light losses in fiber 3 respectively before heating, after heating at 120° C. for 100 h, and after heating at 120° C. for 300 h.

What is claimed is:

1. A photo-crosslinkable composition for fabricating a step-index plastics optical fiber material, said photo-crosslinkable composition comprising:
an acrylate derivative of a compound based on bisphenol, together with a photoinitiator.

2. A photo-crosslinkable composition according to claim 1, wherein the acrylate derivative is selected from an acrylate, a methacrylate, and an α-fluoroacrylate.

3. A photo-crosslinkable composition according to claim 1, wherein the compound from which the acrylate derivative stems is an alkoxy derivative of a bisphenol.

4. A photo-crosslinkable composition according to claim 3, wherein the alkoxy derivative is selected from an ethoxy derivative of a bisphenol and a propoxy derivative of a bisphenol.

5. A photo-crosslinkable composition according to claim 1, wherein the bisphenol based on the acrylate compound is selected from bisphenol A, bisphenol AF, bisphenol M, bisphenol P, bisphenol AP, and bisphenol S.

6. A photo-crosslinkable composition according to claim 1, further comprising a crosslinking agent.

7. A photo-crosslinkable composition according to claim 6, wherein the content of the crosslinking agent lies in the range 0.5% to 5% by weight.

8. A photo-crosslinkable composition according to claim 1, wherein the viscosity of the acrylate derivative lies in the range 0.5 Pa.s to 20 Pa.s, and preferably in the range 1 Pa.s to 5 Pa.s.

9. A method of fabricating a step-index plastics optical fiber material, the method comprising the steps consisting in:
mixing an acrylate derivative of a compound based on a bisphenol and a photoinitiator in order to obtain a photo-crosslinkable composition;
shaping the composition that results from the mixing; and
crosslinking the previously-shaped composition by ultraviolet radiation.

10. A fabrication method according to claim 9, including a step of filtering the acrylate derivative, prior to the mixing step.

11. A fabrication method according to claim 9, wherein a crosslinking agent is added to the composition during the mixing step.

12. A fabrication method according to claim 9, wherein the crosslinking step is implemented continuously.

13. A fabrication method according to claim 9, including an annealing step, subsequent to the crosslinking step.

14. A step-index plastics optical fiber having a core constituted by a core material and cladding constituted by a cladding material, wherein at least one of the core material and the cladding material is made from a photo-crosslinkable composition according to claim 1.
